(19) United States
(12) Patent Application Publication
(10) Pub. No.: US 2007/0159811 A1
(43) Pub. Date: Jul. 12, 2007

(54) Lighting device for keyhole

(75) Inventor: Hsin Chen, Lu Chou City (TW)

Correspondence Address: LEONG C LEI, PMB # 1008, 1867 YGNACIO VALLEY ROAD, WALNUT CREEK, CA, 94598, US

(73) Assignees: Hsin Chen; Chao-Shen Huang; Su-Li Liu

(21) Appl. No.: 11/326,475

(22) Filed: Jan. 6, 2006

(51) Int. Cl. F21V 33/00

(52) U.S. Cl. 362/116

(57) ABSTRACT

A lighting device is provided herein to provide auxiliary lighting in locating keyholes. The device mainly contains a key holding member and a casing member. The bow of a key is fixedly housed inside the key holding member with the blade of the key sticking out in the front. The key holding member in turn is housed inside the casing member, right next to a lamp element, which is connected to the negative electrode of a battery chamber housed in the back of the casing member and a metallic contact blade floating between the positive electrode of the battery chamber and a press button on the top cover of the casing member. The lamp element is turned on when the press button is held down and the contact blade touches the positive electrode.

### BACKGROUND OF THE INVENTION

(a) Technical Field of the Invention

The present invention generally relates to lighting devices, and more particularly to a lighting device for illumination when opening a lock under insufficient lighting.

(b) Description of the Prior Art

Using a key to open a door lock or any other kind of lock is something people do in their daily lives. Aiming and inserting the elongated blade of the key into the tiny keyhole is not difficult when there is sufficient ambient light. However, it is quite common an experience for all people to fumble for the keyhole when opening a lock in the dark or during the night. For senior people or people with inferior eyesight, they are troubled simply when there is insufficient ambient light for them to locate the keyhole.

### SUMMARY OF THE INVENTION

The primary purpose of the present invention is to provides a lighting device for illumination when opening a lock under insufficient lighting.

The lighting device mainly contains a key holding member and a casing member. The bow of a key is fixedly housed inside the key holding member with the blade of the key sticking out in the front. The key holding member in turn is inserted into an opening on the front side of the casing member, and a lamp element is configured right next to the opening.

A terminal of the lamp element is connected to the negative electrode of a battery chamber housed in the back of the casing member. The other terminal of the lamp element is connected to a metallic contact blade floating between the positive electrode of the battery chamber and a press button on the top cover of the casing member. A circuit between the lamp element and the battery chamber is completed when the press button is held down and the contact blade touches the positive electrode, and the lamp element is therefore turned on to provide auxiliary lighting to locate the keyhole.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective exploded view showing the various components of the casing member of the lighting device according to an embodiment of the present invention.

FIG. 2 is a perspective exploded view showing the various components of the key holding member of the lighting device according to an embodiment of the present invention.

FIG. 3 is a perspective view showing the assembly of the key holding member of FIG. 2 and the casing member of FIG. 1 into the lighting device according to an embodiment of the present invention.

FIG. 4 is a perspective view showing the press button of FIG. 2 is engaged to turn on the lighting device of FIG. 3.

FIG. 5 is a cross-sectional view showing the contact of the contact blade to the positive electrode blade when the press button is engaged.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

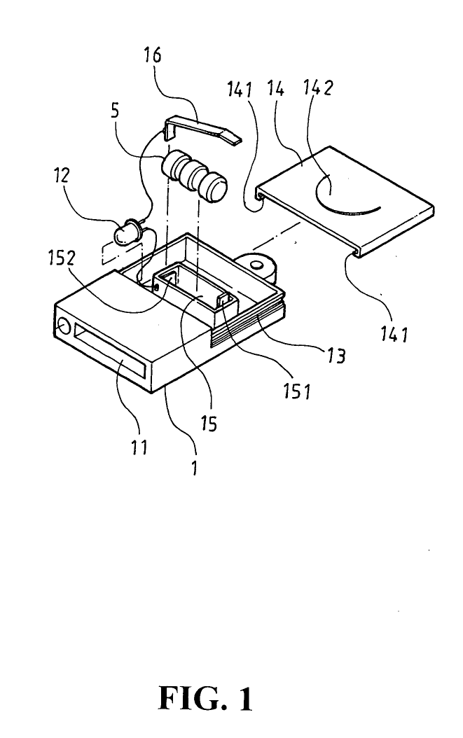

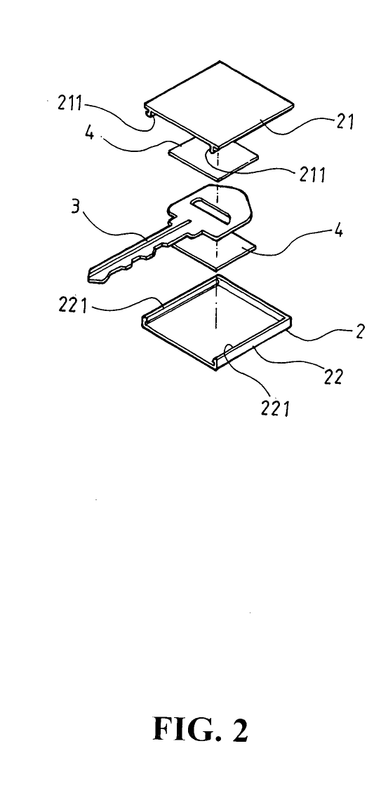

Please refer to FIGS. 1 and 2. As illustrated, an embodiment of the present invention mainly contains a casing member 1 and a key holding member 2. The casing member 1 is a hollow enclosure having an opening 11 on a front side of the enclosure. Also on the front side of the enclosure, a lamp element 12 is configured. Atop side of the enclosure contains a sliding cover 14 which can be slid backward (i.e., opposite to the front side) to expose the interior of the enclosure. Within the exposed space of the enclosure, there is an elongated battery chamber 15 with positive and negative electrode blades 151 and 152 at the two ends of the chamber 15. The positive electrode blade 151 is extended upward for an appropriate distance over the chamber 15. An elongated metallic contact blade 16 has one of its ends fixed to the outside of the batter chamber 15 at the end where the negative electrode blade 152 is placed. The contact blade 16 is then extended over and parallel to the battery chamber 15 until the other end of the contact blade 16 is over, but not contacting, the positive electrode blade 151 at an appropriate distance.

The lamp element 12 is a light emitting diode or a miniature light bulb, whose two terminals are connected to the contact blade 16 and the negative electrode blade 152, respectively.

A sliding mechanism is configured between the sliding cover 14 and the enclosure of the casing member 1, which contains matching tracks 13 and rails 141 configured along the lateral sides of the enclosure and the sliding cover 14 respectively. A curved slit is carved on the sliding cover 14 to form a floating, resilient, semi-circular press button 142 on the sliding cover 14.

The key holding member 2 contains a top cap element 21 and a matching bottom cap element 22, joined together by a locking mechanism including corresponding hooked edges 211 and 221 along the lateral and back sides of the top and bottom cap elements 21 and 22 respectively. The bow of a key 3, after being applied double-sided scotch tapes to its both sides, is laid flat and sealed inside the key holding member 2. The blade of the key 3 sticks out of the front side of the key holding member 2.

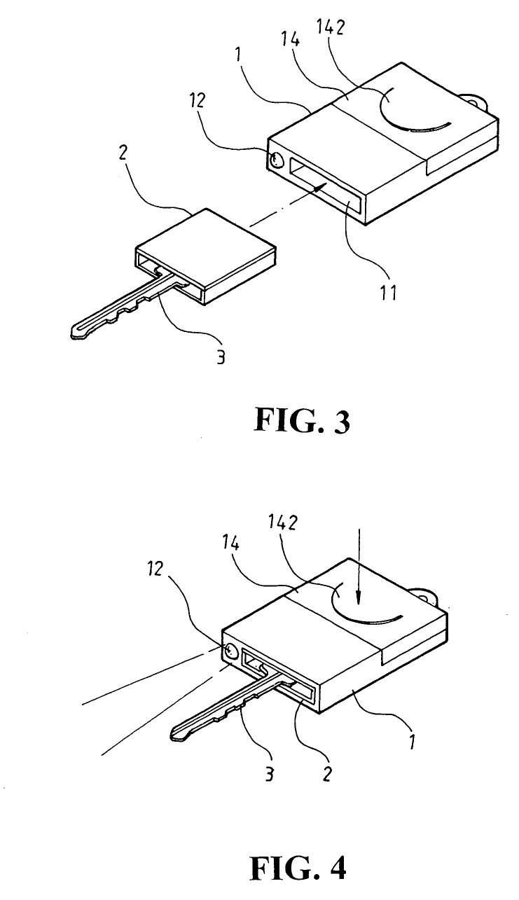

To put the lighting device into use, one or more batteries 5 are installed inside the battery chamber 15 and the sliding cover 14 is slid to seal the exposed space along the track and rail 13 and 141. Then, as shown in FIG. 3, the key holding member 2, along with the affixed key 3, is inserted into the casing member 1 via the opening 11. Please note that the key holding member 2 and the casing member 1 are designed and configured such that the key holding member 2 is tightly enclosed inside the casing member 1.

As shown in FIG. 4, when using the lighting device in the dark or under insufficient lighting, a user can use his or her thumb to push the press button 142, which in turn forces the floating end of the contact blade 16 to touch the positive electrode blade 151, thereby completing a circuit between the lamp element 12 and the batteries 5. The lamp element 12 therefore is turned on to provide auxiliary lighting for the user to locate the keyhole.

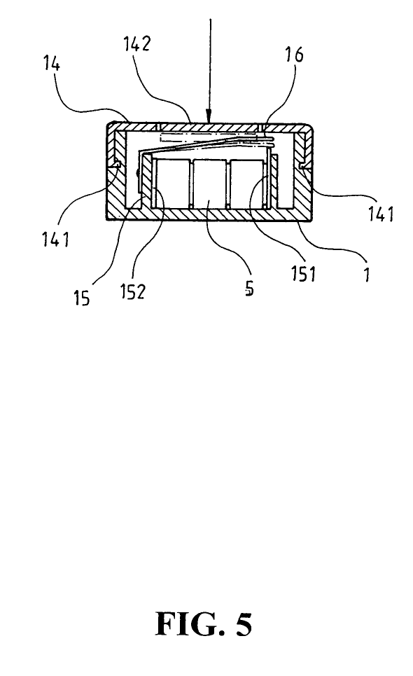

As shown in FIG. 5, as long as the user holds down the press button 142 and the contact blade 16 remains in touch with the positive electrode blade 151, the lamp element 12 would be lit continuously. The press button 142 and the contact blade 16 are endowed with certain flexibility by the ways they are configured. Therefore, when the pressure on the press button 142 is removed, both the press button 142 and the contact blade 16 are restored to their original positions automatically, thereby breaking up the electrical circuit between the lamp element 12 and the batteries 5. The lamp element 12 is therefore turned off.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A lighting device for use with a key, comprising a casing member and a key holding member, wherein
said casing member is a hollow enclosure with an opening on a front side and a sliding cover on a top side of said enclosure, said sliding cover has a resilient area, a battery chamber is housed inside said enclosure and exposed by removing said sliding cover, a first and a second electrode blade are configured at the two ends of said battery chamber respectively with said second electrode blade extended upward for an appropriate distance over said battery chamber, a metallic contact blade has one end fixed to an appropriate location inside said enclosure and has the other end floating between said resilient area of said sliding cover and said second electrode blade, a lamp element is configured on said enclosure substantially adjacent to said opening, said lamp element is connected to said first electrode blade and said contact blade;
said key holding member comprises a top cap element and a matching bottom cap element, joined together by a locking mechanism including corresponding hooked edges along the lateral and back sides of the top and bottom cap elements respectively; and
the bow of said key is fixedly housed inside said key holding member with the blade of said key sticking out in the front, said key holding member is inserted into said casing member via said opening, said lamp element is turned on when said resilient area is held down and said contact blade touches said second electrode blade to complete a circuit between said lamp element and said battery chamber.

2. The lighting device according to claim 1, wherein said resilient area of said sliding cover is formed by carving a substantially semi-circular slit on said sliding cover.
